(19) United States
(12) Patent Application Publication
(10) Pub. No.: US 2026/0265007 A1
(43) Pub. Date: Sep. 10, 2026

(54) FOOD DISPENSER

(71) Applicant: Duke Manufacturing Co., St. Louis, MO (US)

(72) Inventors: Travis Mills, St. Louis, MO (US); John J. Hake, Edwardsville, IL (US)

(21) Appl. No.: 19/166,199

(22) PCT Filed: Mar. 15, 2024
(86) PCT No.: PCT/US2024/020158

§ 371 Date: Sep. 17, 2025

Related U.S. Application Data
(60) Provisional application No. 63/490,917, filed on Mar. 17, 2023.

(51) Int. Cl. B65G 59/06; A47J 37/00

(52) U.S. Cl. CPC B65G 59/068; A47J 37/00; B65G 2201/0202

(57) ABSTRACT

A food dispenser for dispensing food items. The food dispenser includes a food loader and a food holder. The food loader moves the food items and includes a moveable conveyor and a pusher secured to and moveable with the conveyor. The food holder has a food receiving space sized and shaped to receive the food items in a stack. The food holder includes a food support that supports the stack of food items when the stack is placed thereon. The food support overlies the conveyor and is arranged to support the stack of food items such that the stack of food items is spaced apart from and above the conveyor. The pusher pushes a bottom-most food item of the food items out from the stack of food items and onto the conveyor as the pusher moves with the conveyor.

### CROSS-REFERENCE TO RELATED APPLICATION

This application claims the benefit of U.S. Provisional Application No. 63/490,917, filed Mar. 17, 2023, the entirety of which is hereby incorporated by reference.

### FIELD

The present disclosure generally relates to food serving equipment, and more particularly to a food dispenser for dispensing food items.

### BACKGROUND

This disclosure is directed to a food dispenser that dispenses food items, such as frozen patties. Such equipment is used in the fast food service industry to dispense food items to a food cooking device to be cooked.

### SUMMARY

In one aspect, a food dispenser for dispensing food items comprises a food loader configured to move the food items. The food loader includes a moveable conveyor and a pusher secured to and moveable with the conveyor. A food holder has a food receiving space sized and shaped to receive the food items in a stack. The food holder includes a food support arranged to support the stack of food items thereon. The food support overlies the conveyor and is arranged to support the stack of food items such that the stack of food items is spaced apart from and above the conveyor. The pusher is configured to push a bottom-most food item of the food items out from the stack of food items and onto the conveyor as the pusher moves with the conveyor.

Other objects and features will be in part apparent and in part pointed out hereinafter.

### BRIEF DESCRIPTION OF THE DRAWINGS

FIG. 1 is a front perspective of a food dispenser according to one embodiment of the present disclosure;

FIG. 2 is a rear perspective of the food dispenser;

FIG. 3 is a perspective of the food dispenser, with a portion thereof removed to show additional details;

FIG. 4 is a perspective of a food loader of the food dispenser; and

FIG. 5 is cross-section of the food dispenser, the food dispenser containing a stack of food items.

Corresponding reference characters indicate corresponding parts throughout the drawings.

### DETAILED DESCRIPTION

The present disclosure relates to a food dispenser that dispenses food items, such as individual meat burger patties, individual imitation meat burger patties, etc., to be cooked by a food cooking device (not shown), such as an oven. The food dispenser shown and described herein can be used to dispense food for other reasons without departing from the scope of the present disclosure.

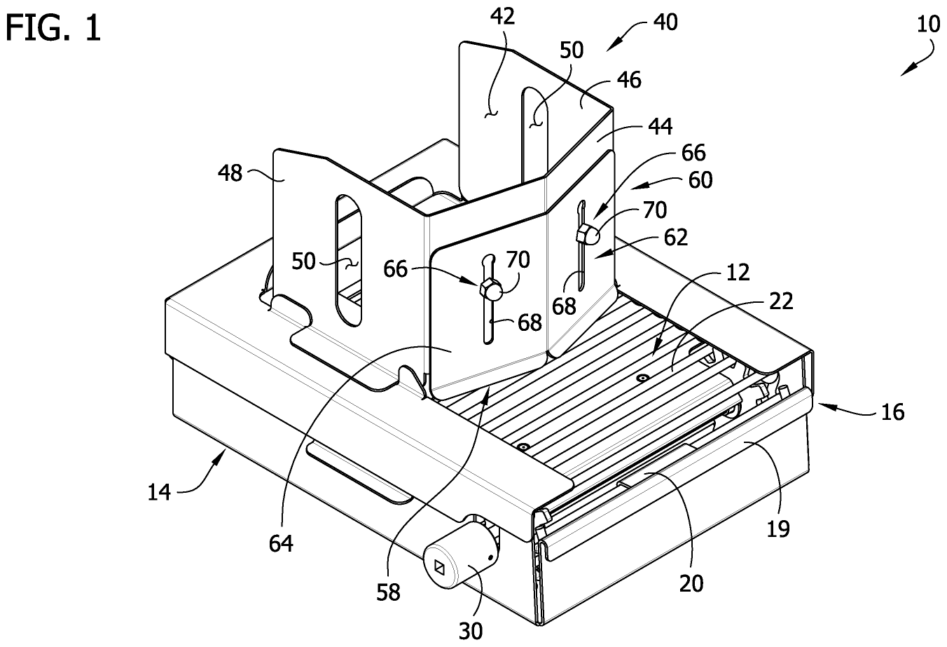

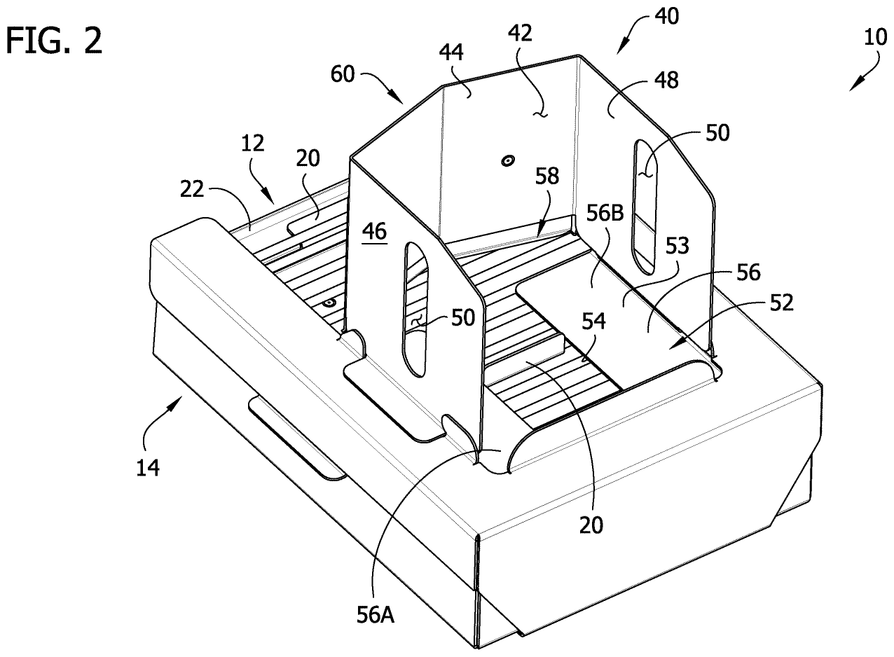

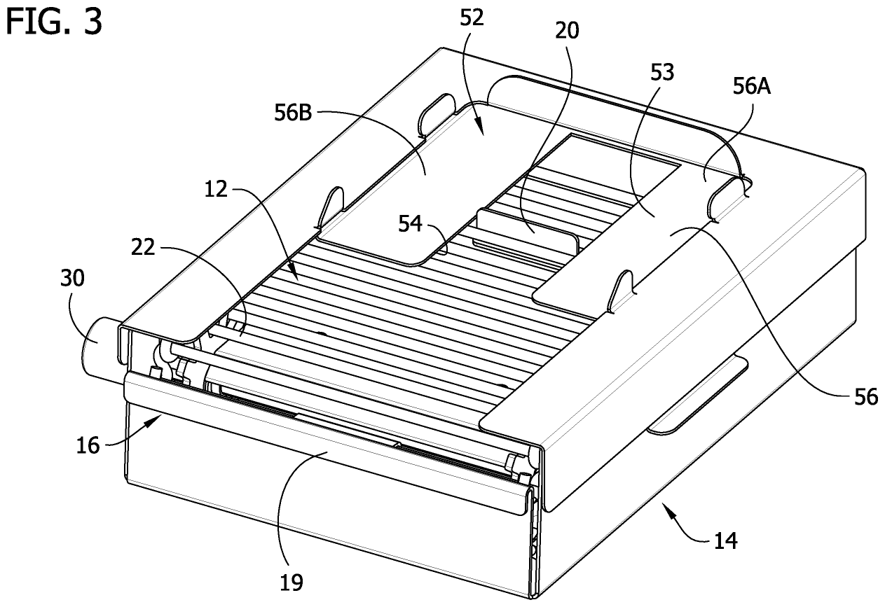

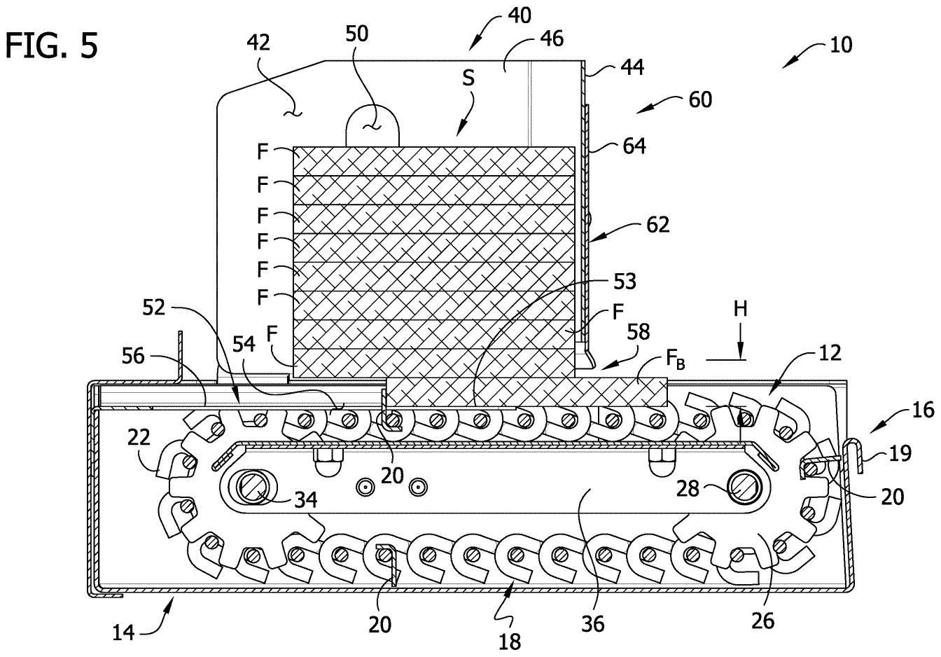

Referring to FIGS. 1-5, a food dispenser according to one embodiment of the present disclosure is generally indicated by reference numeral 10. The food dispenser 10 dispenses individual food items F (FIG. 5), one at a time, desirably to a food cooking device. In one embodiment, the food dispenser 10 dispenses the food items F and loads or inserts the food items toward, to, or into the food cooking device. The food dispenser 10 is generally configured to dispense frozen patties (meat burger patties, imitation meat burger patties, etc.) but may be used for dispensing other types of food items. The food dispenser 10 can be part of a food cooking system. The food cooking system including the food cooking device and the food dispenser 10 for dispensing the food items to the food cooking device. The food cooking device may be an oven, although other food cooking devices may be used without departing from the scope of the present disclosure. In one embodiment, the food items F are dispensed by the food dispenser 10 and then cooked by the food cooking device.

The food dispenser 10 includes a food loader 12 configured to move the food items F. In one embodiment, the food loader 12 moves or loads the food items F into the food cooking device. The food dispenser 10 includes a housing or frame 14 that supports the food loader 12. The food loader 12 is generally housed or contained within the housing 14. In the illustrated embodiment, the housing 14 has an interior and the food loader 12 is disposed in the interior of the housing. In the illustrated embodiment, the food dispenser 10 is configured to be mounted on and supported by the food cooking device, although other ways of arranging the food dispenser relative to the food cooking device or any other device may be used without departing from the scope of the present disclosure. The housing 14 may include a mount 16 configured to attach to the food cooking device to attach or mount the food dispenser 10 to the food cooking device. In the illustrated embodiment, the mount 16 comprises a hook 19, although other types of mounts may be used without departing from the scope of the present disclosure. The hook 19 is configured to hook onto the food cooking device. Specifically, the hook 19 is positioned over an exposed edge (e.g., upward facing edge) of a wall (e.g., sheet metal wall) of the food cooking device. With the hook 19 hooked over the edge of the wall, the front of the housing abuts a face of the wall, thereby positioning the food dispenser on the food cooking device. The exposed edge of the food cooking device may be located at an inlet of the food cooking device such that, when mounted to the food cooking device, the food dispenser is arranged to load the food items F directly to the food cooking device. Alternatively or in addition to the hook 19, the food dispenser 10 may include other types of mounts such as one or more mounting brackets and/or fasteners (e.g., bolts, screws, etc.) to mount the housing (broadly, the food dispenser) to the food cooking device. Other ways of mounting the food dispenser 10 to the food cooking device may be used without departing from the scope of the present disclosure.

The food loader 12 includes a moveable conveyor 18 and one or more pushers 20 secured to and movable with the conveyor. In the illustrated embodiment, the food loader 12 includes three pushers 20 secured to and movable with the conveyor 18, although more or fewer pushers may be used without departing from the scope of the present disclosure. The pushers 20 are spaced apart from one another along the conveyor 18. The conveyor 18 includes a movable surface that moves the food items F, such as toward the food cooking device. The movable surface is arranged to support and carry the food items F as the conveyor 18 moves. In the illustrated embodiment, the conveyor 18 is an endless conveyor. In the illustrated embodiment, the conveyor 18 comprises a rod (e.g., wire rod) conveyor belt 22, although other types of conveyor belts (e.g., wire-link) and other types of conveyors may be used without departing from scope of the present disclosure. In this embodiment, the movable surface is formed by the crosswise rods or links in the upper portion conveyor belt 22. Each pusher 20 is fixed to a rod of the conveyor belt 22 (broadly, each pusher is attached to the movable surface of the conveyor 18). As a result, the pushers 20 move with the conveyor belt 22 (broadly, the conveyor 18). In one embodiment, each pusher 20 is welded to its corresponding rod of the conveyor belt, although other ways of attaching the pushers to the conveyor belt may be used without departing from the scope of the present disclosure. In the illustrated embodiment, each pusher 20 comprises a generally L-shaped tab (broadly, “lug” protruding with respect to the conveyor belt) arranged such that a leg or wall of the tab extends upward (e.g., vertically upward) when the pusher is on the topside of the conveyor 18. Other configurations of the pushers may be used without departing from the scope of the present disclosure.

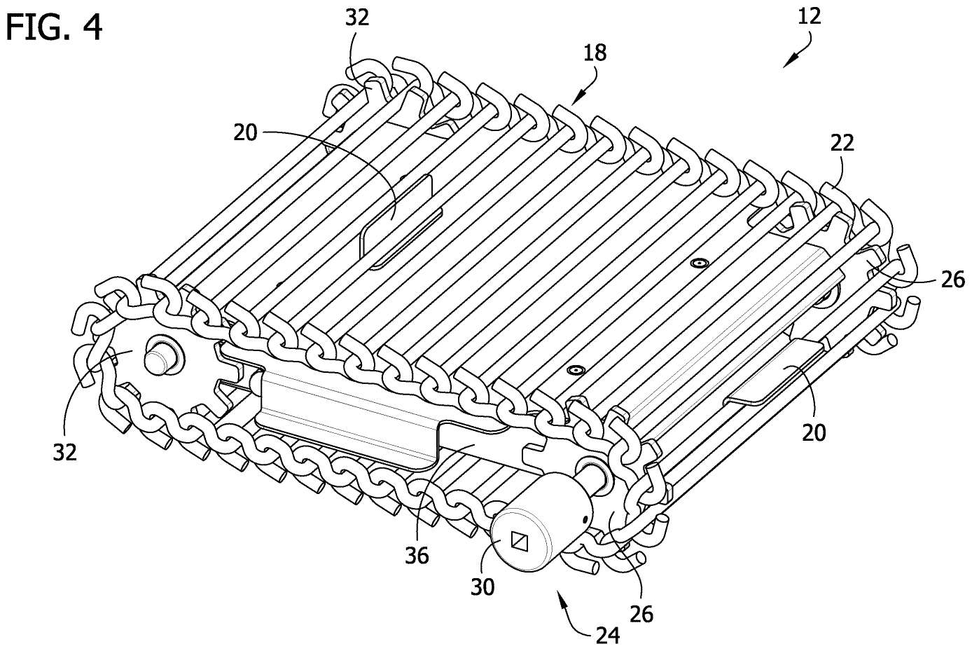

Referring to FIG. 4, the food loader 12 includes a drive train 24 to drive movement of the conveyor 18 (specifically, the conveyor belt 22) and pushers 20. The drive train 24 includes a conveyor driver having two drive pinions or gears 26 connected by a drive axle 28.

The drive pinions 26 are engaged (e.g., meshed) with the conveyor belt 22 such that rotation of the drive pinons moves the conveyor belt (broadly, the movable surface or even more broadly, the conveyor 18) and pushers 20 to move the food items F. The drive train 24 also includes a drive connector 30 (broadly, “linkage”) coupled to the conveyor driver (specifically, the drive axle 28), such that rotation of the drive connector rotates the drive axle and therefore the drive pinions 26. The drive train 24 also includes a conveyor follower comprising two follower pinions or gears 32 connected by a follower axle 34. The follower pinions 32 and follower axle 34 permit the conveyor 18 to move under the force of the conveyor driver. The food loader includes a food loader frame 36 which supports the drive train 24. The loader frame 36 is attached to and supported by the housing 14. The drive and follower axles 28, 34 extend through and rotate within respective openings in the loader frame 36.

In one embodiment, the food dispenser 10 includes a motor. The drive train 24 operatively connects the motor to the conveyor 18 such that operation (e.g., rotation of an output shaft of the motor) of the motor results in movement of the conveyor 18. In other embodiments, the drive train 24 may be operatively coupled to the food cooking device such that the food cooking device drives movement of the conveyor 18 (via the drive train). For example, the drive connector 30 can be operatively coupled to a driver of the food cooking device. The drive connector can be coupled to a driven gear which is rotated by a chain driven by a drive gear of the food cooking device. In this embodiment, the driven and drive gears are sized such that the conveyor 18 of the food dispenser 10 moves at generally the same speed as a conveyor in the food cooking device (if the food cooking device includes a conveyor). Other ways of the food cooking device being coupled to and/or driving movement of the conveyor 18 of the food dispenser 10 may be used without departing from the scope of the present disclosure.

Referring to FIGS. 1, 2, 4 and 5, the food dispenser 10 includes a food holder or hopper 40 for holding a plurality of food items F. The food holder holds the food items F in a stack S (FIG. 5), with the food items stacked one on top of the other. The food holder 40 is attached to and supported by the housing 14. The food holder 40 is disposed above the food loader 12. The food holder 40 includes (e.g., defines) a food receiving space 42. The food receiving space 42 is sized and shaped to receive the food items F in the stack S. The food holder 40 includes a plurality of walls defining the food receiving space 42. The food holder 40 includes a front wall 44, a left side wall 46, and a right side wall 48. The front wall 44 generally bounds the front of the food receiving space 42, the left side wall 46 generally bounds the left side of the food receiving space, and the right side wall 48 generally bounds the right side of the food receiving space. One or more of the walls can include one or more windows 50 to permit an operator to see into the food receiving space and view/determine the amount of food items F remaining in the food holder 40. In the illustrated embodiment, each of the side walls 46, 48 includes a window 50. The rear and the top of the food receiving space 42 is open to allow easy access to the food receiving space, making it easier to insert a stack S of food items F into the food receiving space and place the items on the food support 52 (described below). In other words, the food holder 40 lacks a rear wall or other component closing the rear of the food receiving space 42. Being able to directly place the stack S of food items F on the food support 52 (e.g., from behind without dropping the stack) improves the loading of the food dispenser over conventional systems where the stack has to be dropped down into a food holder which can result in the food items in the bottom of the stack becoming skewed/angled in the conventional food holder as they fall down, jamming up the food holder.

The food holder 40 includes a food support 52. The food support 52 is arranged to support the stack S of food items F thereon (FIG. 5). The food support 52 is at the bottom of the food receiving space 42 (e.g., the food support bounds the bottom of the food receiving space). The food support 52 is arranged to support the stack S of food items F such that the stack of food items is spaced apart from and above (e.g., vertically above) the conveyor 18 (specifically, the conveyor belt 22). The food support 52 overlies the food loader 12, specifically the conveyor 18. The food support 52 is spaced apart from and is above (e.g., vertically above) the conveyor 18. The stack S of food items F rests on and is supported by the food support 52. As a result, the stack S of food items F is positioned above the conveyor belt 22. The food support 52 includes a food support surface 53, which is generally planar and parallel to the movable surface of the conveyor belt 22, which the stack S of food items F rests on and is supported by. Other configurations can be used without departing from the scope of the present disclosure.

To dispense the food items F, each pusher 20 is configured to push the bottom-most food item F_{B} in the stack S of food items F out from the stack and onto the conveyor 18 as the pusher moves with the conveyor. As used herein, reference character “F” is used to designate and refer to all food items (including the bottom-most food item), and reference character “F_{B}” is used to specifically designate and reference the food item that is at the bottom of the stack S. As each pusher 20 pushes the bottom-most food item F_{B}, the bottom-most food item slides along the food support 52 and onto the conveyor 18, specifically, the movable surface formed by the conveyor belt 22. The food support 52 includes an opening 54. The opening 54 is sized and shaped to permit each pusher 20 to move within and along the opening. This allows each pusher 20 engage and push the bottom-most food item F in the stack S as the pushers move along the food support 52. Each pusher 20 is configured to move within the opening 54 as the pushers move with the conveyor 18. Specifically, each pusher 20 moves into and out of the opening 54 as the pushers rotate about or move with the conveyor belt 22. Each pusher 20 moves into and out of the opening 54 to push the bottom-most food item F_{B} out from the stack S of food items F (e.g., off of the food support 52) and onto the conveyor 18. In the illustrated embodiment, the opening 54 comprises a slot extending back-to-front or parallel with the direction of movement of the pushers 20 (and thereby the food items F) when the pushers are pushing the food items. The slot has a rearward or upstream end and an opposite front or downstream end. The downstream end of the slot is open to allow the pushers 20 to move there-through when each pusher is pushing the bottom-most food item F_{B}. In operation, the pushers 20 extend up through the food support surface 53 when the pushers are pushing the bottom-most food item F_{B}. In other words, the pushers 20 extend up through the opening 54 to engage and push the bottom-most food item F_{B}. Other configurations can be used without departing from the scope of the present disclosure.

In the illustrated embodiment, the food support 52 comprises a floor 56. The floor 56 includes first and second floor sections 56A, 56B on either side of the opening 54. The first floor section 56A bounds a left side of the opening 54 and the second floor section 56B bounds a right side of the opening. The open downstream end of the opening 54 extends between the two floor sections 56A, 56B.

The food support 52 is spaced above the conveyor 18 and supports the stack S of food items F above the conveyor. In this manner, the food support 52 prevents the bottom-most food item F_{B} in the stack S from being in contact with the conveyor 18 while the bottom-most food item is in the stack. The stack of food items is not supported directly by the conveyor. Such an arrangement may result in the conveyor deforming or damaging (e.g., tearing, ripping, etc.) the bottom of the food items as the conveyor moves relative to the stack of food items (which is stationary relative to the conveyor), before moving with the conveyor. The food support 52 of the present food dispenser 10 supports the stack S of food items F off the conveyor 18, thereby allowing the conveyor to move relative to the stack of food items without damaging them. When the pusher 20 comes along, the bottom-most food item F_{B} slides along the food support 52, and onto the conveyor 18, thereby moving with the conveyor. This way the food items F contact the conveyor 18 only when moving with the conveyor.

The food holder 40 includes a food item opening or outlet 58 sized and shaped to permit one food item F at a time to move there-through. Specifically, the food item opening 58 is sized and shaped to permit the bottom-most food item F_{B} to move there-through as the bottom-most food item is being pushed by one of the pushers 20. The food item opening 58 is disposed at the base of the food receiving space 42, at a front thereof. The food holder 40 includes a food brace 60. The food brace 60 is arranged to brace the stack S of food items F when the pushers are pushing the bottom-most food items F_{B} so that the bottom-most food item moves relative to remaining food items in the stack of food items. In other words, the food brace 60 allows only the bottom-most food item F_{B} to move with the pushers 20, not the entire stack S of food items F. The food brace 60 defines the food item opening 58, specifically, the top of the food item opening. In the illustrated embodiment, the food brace 60 is adjustable to change a size of the food item opening 58. More specifically, the food brace 60 is adjustable to change a height H (FIG. 5) of the food item opening 58. In the illustrated embodiment, the height H of the food item opening 58 is the vertical measurement from an imaginary plane in which the food support surface 53 lies to the portion of the food brace 60 bounding the top of the food item opening 58. This allows the food item opening 58 to be adjusted to conform the food item opening to different heights of food items F. The food brace 60 includes the front wall 44 and an adjuster 62. The adjuster 62 is moveable relative to the front wall 44 to change the height H of the food item opening 58. In the illustrated embodiment, the adjuster 62 is mounted to the front wall 44 and is selectively fixable in various positions on the front wall to adjust the height H of the food item opening 58. The adjuster 62 includes a wall 64 attached to the front wall 44 of the food holder 40 with one or more retainers 66. Each retainer 66 includes a threaded fastener or rod attached to the front wall 44 that extend through a vertical slot 68 in the wall 64 of the adjuster 62. Each retainer 66 includes a nut 70, such as a cap or acorn nut, (broadly, a retainer actuator) threaded onto the threaded fastener. The nut 70 is tightened against the wall 64 of the adjuster 62 to secure the wall in position relative to the front wall 44 (e.g., set the height H of the food item opening 58) and is loosened to permit the wall 64 to move relative to the front wall 44 to change the height of the foot item opening. To change the height H of the food item opening 58, an operator loosens the nuts 70 (broadly, releases the retainers 66), slides the wall 64 vertically (up or down) to a desired location and then tightens the nuts (broadly, sets the retainers) to secure the adjuster 62 in place. Other ways of changing the height of the food item opening may be used without departing from the scope of the present disclosure.

In the illustrated embodiment, the wall 64 of the adjuster 60 includes an angled or tapered flange at the bottom of the wall (and bounding the top of the food item opening 58) to facilitate and guide movement of the food item F_{B} through the food item opening (should the food item come into contact with the wall 64).

The operation of the food dispenser 10 will now be described. The user or operator places a stack S of food items F in the food holder 40. If needed, the user adjusts the height H of the food item opening 58, as described herein, to conform the height to the thickness of the food items (e.g., make the height slightly larger than the thickness). To dispense the food items F, the drive train 24 (driven by a motor or a food cooking device, etc.) drives movement of the conveyor 18 and pushers 20. As the conveyor 18 moves, a first of the pushers 20 moves into the opening 54 and comes into contact with the bottom-most food item F_{B} in the stack S. As the conveyor 18 continues to move, this first pusher 20 pushes the bottom-most food item F_{B} toward and through the food outlet (FIG. 5). As the first pusher 20 is pushing the bottom-most food item F_{B}, the food brace 60 braces and retains the other food items F in the stack S in the food receiving space 42. The food brace 60 engages the remaining food items F in the stack S and inhibits these food items from moving with the bottom-most food item F_{B} as the bottom-most food items is moved by the first pusher 20. The first pusher 20 continues pushing the bottom-most food item F_{B} along the food support 52 and through the food item opening 58. When the bottom-most food item F_{B} is clear of the stack S, the stack drops down to the food support 52, thereby positioning the next food item (formerly second-to-bottom-most food item and now the new bottom-most food item) to be engaged by the next (e.g., second) pusher 20. When clear of the food item opening 58, the food item F is supported by the conveyor 18. The conveyor 18 and the first pusher 20 continue to move the food item F to dispense the food item, such as by loading the food item to a food cooking device. This process then repeats for the next (e.g., second) pusher 20 on the conveyor 18 to dispense the new bottom-most food item F_{B} and so on.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the present disclosure are achieved and other advantageous results attained.

As various changes could be made in the above constructions and methods without departing from the scope of the present disclosure, it is intended that all matter contained in the above description and shown in the accompanying drawings shall be interpreted as illustrative and not in a limiting sense.

1. A food dispenser for dispensing food items, the food dispenser comprising:
a food loader configured to move the food items, the food loader including a moveable conveyor and a pusher secured to and moveable with the conveyor; and
a food holder having a food receiving space sized and shaped to receive the food items in a stack, the food holder including a food support arranged to support the stack of food items thereon, the food support overlying the conveyor and being arranged to support the stack of food items such that the stack of food items is spaced apart from and above the conveyor;
wherein the pusher is configured to push a bottom-most food item of the food items out from the stack of food items and onto the conveyor as the pusher moves with the conveyor.

2. The food dispenser of claim 1, wherein the food support defines an opening, the pusher being configured to move within the opening as the pusher moves with the conveyor.

3. The food dispenser of claim 2, wherein the pusher and the opening are arranged relative to one another such that the pusher is configured to move into and out of the opening to push the bottom-most food item out from the stack of food items and onto the conveyor.

4. The food dispenser of claim 2, wherein the opening comprises a slot, the slot having an upstream end and a downstream end, the downstream end of the slot being open to allow the pusher to move through the downstream end of the slot when the pusher is pushing the bottom-most food item.

5. The food dispenser of claim 1, wherein the food support comprises a floor.

6. The food dispenser of claim 1, wherein the food support includes a food support surface on which the stack of food items is supported, and wherein the pusher is configured to protrude upward with respect to the food support surface when the pusher is pushing the bottom-most food item.

7. The food dispenser of claim 1, wherein the conveyor comprises an endless conveyor.

8. The food dispenser of claim 7, wherein the endless-conveyor includes a rod conveyor belt.

9. The food dispenser of claim 8, wherein the pusher is secured to a rod of the rod conveyor belt.

10. The food dispenser of claim 9, wherein the pusher is welded to the rod of the rod conveyor belt.

11. The food dispenser of claim 1, wherein the pusher is first pusher, and wherein the food loader includes a second pusher secured to and moveable with the conveyor, the second pusher being spaced from the first pusher, and wherein the second pusher is configured to push a subsequent bottom-most food item of the stack of food items out from the stack of food items and onto the conveyor as the second pusher moves with the conveyor.

12. The food dispenser of claim 1, wherein the food loader includes a drive train configured to move the conveyor.

13. The food dispenser of claim 12, further comprising a motor, the drive train operatively connecting the motor to the conveyor such that operation of the motor results in movement of the conveyor.

14. The food dispenser of claim 1, wherein the food holder includes a food brace arranged to brace the stack of food items when the pusher pushes the bottom-most food item so that the bottom-most food item moves relative to remaining food items in the stack of food items.

15. The food dispenser of claim 1, wherein the food holder includes a food item opening sized and shaped to permit the bottom-most food item to move there-through as the bottom-most food item is being pushed by the pusher.

16. The food dispenser of claim 1, wherein the food holder includes:
a food item opening sized and shaped to permit the bottom-most food item to move there-through as the bottom-most food item is being pushed by the pusher; and
a food brace arranged to brace the stack of food items when the pusher pushes the bottom-most food item through the food item opening so that the bottom-most food item moves relative to remaining food items in the stack of food items, the food brace defining the food item opening, the food brace being adjustable to change a size of the food item opening.

17. The food dispenser of claim 16, wherein the food brace is adjustable to change a height of the food item opening.

18. The food dispenser of claim 1, further comprising a housing, the food loader disposed in the housing.

19. The food dispenser of claim 18, wherein the housing includes a mount configured to attach to a food cooking device to attach the food dispenser to the food cooking device.

20. The food dispenser of claim 19, wherein the mount includes a hook configured to hook onto the food cooking device.
